(19) United States
(12) Patent Application Publication
(10) Pub. No.: US 2008/0205848 A1
(43) Pub. Date: Aug. 28, 2008

(54) Imaging apparatus and reproducing apparatus

(75) Inventor: Kazuhide Kobayashi, Yokohama-shi (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: Victor Company of Japan, Ltd., Yokohama-shi (JP)

(21) Appl. No.: 12/072,310

(22) Filed: Feb. 26, 2008

(30) Foreign Application Priority Data
Feb. 28, 2007 (JP) JP 2007-049117
Feb. 28, 2007 (JP) JP 2007-049118
Mar. 30, 2007 (JP) JP 2007-093161
Dec. 28, 2007 (JP) JP 2007-340173

(51) Int. Cl. H04N 5/913

(52) U.S. Cl. 386/94; 386/E05.004

(57) ABSTRACT

An imaging unit takes an image and converts the image into a video signal. A display unit displays the image carried the by the video signal. An average luminance calculating unit calculates average luminance of the image per first predetermined period. A detecting unit calculates a ratio of maximum to minimum average luminance of the average luminance over a second predetermined period that is an integer multiple of the first predetermined period and determines whether the ratio is equal to or higher than a predetermined value. The detecting unit determines that the image taken by the imaging unit is an image of a movie projected onto a screen when it is determined that the ratio is equal to or higher than the predetermined value. A warning unit sends a warning signal to the display unit when the detecting unit determines that the image taken by the imaging unit is the image of the movie. The display unit then displays an warning message carried by the warning signal with the image.

### CROSS-REFERENCE TO RELATED APPLICATIONS

This application is based on and claims the benefit of priority from the prior Japanese Patent Application Nos. 2007-049117 filed on Feb. 28, 2007, 2007-049118 filed on Feb. 28, 2007, 2007-093161 filed on Mar. 30, 2007, and 2007-340173 filed on Dec. 28, 2007, the entire contents of which is incorporated herein by reference.

### BACKGROUND OF THE INVENTION

The present invention relates to an imaging apparatus equipped with a function capable of preventing surreptitious recording of video contents such as a movie at a theater and a reproducing apparatus equipped with a function capable of preventing reproduction of such surreptitiously recorded video contents.

There is a problem in that video contents such as a movie is surreptitiously recorded without authorization at a theater and then pirated media such as DVDs are produced. Such copyright piracy becomes a bigger problem with advancement of high-resolution imaging apparatuses for HD (High Definition) televisions.

One scheme for preventing such surreptitious video recording is given by U.S. Patent Application Publication No. US 2003/0219231A1 (referred to as Document 1, hereinafter). In Document 1, unauthorized video recording is prevented with an infrared signal of a sequence of coded pulses (a remote imaging-apparatus control signal) transmitted by several transmitters arranged in a theater.

Another scheme for preventing such surreptitious video recording is given by Japanese Un-examined Patent Publication No. 2005-051487 (referred to as Document 2, hereinafter). In Document 2, unauthorized video recording is prevented with a passive or an active RF (Radio Frequency) tag installed in an imaging apparatus. Unauthorized recording is checked with tag data read by an RF-tag reader when a person carrying the imaging apparatus enters and leaves a theater.

Such schemes, however, have several disadvantages as discussed below.

The scheme in Document 1 requires several transmitters to be arranged in a theater, for use in transmission of an infrared signal as a remote imaging-apparatus control signal.

The scheme in Document 2 requires that an imaging apparatus to be used for surreptitious video recording be installed with an RF tag, and an RF-tag reader and a database server for managing RF tags be set in a theater.

Moreover, the schemes in Documents 1 and 2 require that an imaging apparatus receive an infrared control signal and an RF signal, respectively, for prevention of surreptitious video recording. Surreptitious video recording is thus easily performed with a means for shielding such an infrared control signal or an RF signal, installed in an imaging apparatus.

Another problem lies in reproducing apparatuses. Pirated images are reproduced by ordinary reproducing apparatuses with no means for determining whether the images are those surreptitiously recorded at a theater.

### SUMMARY OF THE INVENTION

A purpose of the present invention is to provide an imaging apparatus equipped with a function capable of preventing surreptitious recording of video contents such as a movie at a theater and a reproducing apparatus equipped with a function capable of preventing reproduction of surreptitiously recorded video contents, so that a theater requires no equipment arrangement or addition.

The present invention provides an imaging apparatus comprising: an imaging unit for taking an image and converting the image into a video signal; a display unit for displaying the image carried the by the video signal; an average luminance calculating unit for calculating average luminance of the image per first predetermined period; a detecting unit for calculating a ratio of maximum to minimum average luminance of the average luminance over a second predetermined period that is an integer multiple of the first predetermined period and determining whether the ratio is equal to or higher than a predetermined value, to determine that the image taken by the imaging unit is an image of a movie projected onto a screen when it is determined that the ratio is equal to or higher than the predetermined value; and a warning unit for sending a warning signal to the display unit when the detecting unit determines that the image taken by the imaging unit is the image of the movie, thus the display unit displays an warning message carried by the warning signal with the image.

Moreover, the present invention provides a reproducing apparatus comprising: a reproducing unit for reproducing an image from a video signal; an average luminance calculating unit for calculating average luminance of the image reproduced from the video signal per first predetermined period; a detecting unit for calculating a ratio of maximum to minimum average luminance of the average luminance over a second predetermined period that is an integer multiple of the first predetermined period and determining whether the ratio is equal to or higher than a predetermined value, to determine that the image reproduced from the video signal is an image of a movie projected onto a screen when it is determined that the ratio is equal to or higher than the predetermined value; and a warning unit for sending a warning signal to the reproducing unit when the detecting unit determines that the image reproduced from the video signal is the image of the movie, thus the reproducing unit sends out an warning message carried by the warning signal with the image for displaying.

Here, the term “detecting unit” is interpreted as a detecting unit or a control unit, according to the disclosure hereinbelow. In the disclosure, the function of detecting surreptitious video recording according to the present invention is provided to the control unit in addition to the function of overall control of the imaging or reproducing apparatus, or provided to the detecting unit. When the surreptitious video-recording function is provided to the detecting unit, the control unit has the function of overall control of the imaging or reproducing apparatus only.

### BRIEF DESCRIPTION OF DRAWINGS

FIG. 1 shows a block diagram of an imaging apparatus, a first embodiment of the present invention;

FIG. 2 illustrates a relation between movie frames and video recording fields;

FIG. 3 illustrates how a movie is projected onto a screen;

FIG. 4 illustrates change in field average luminance over video recording fields in normal video recording;

FIG. 5 illustrates change in field average luminance over video recording fields in surreptitious movie recording;

FIG. 6 also illustrates change in field average luminance over video recording fields in surreptitious movie recording;

FIG. 7 shows a flowchart for explaining the function of the imaging apparatus for prevention of surreptitious movie recording, in the first embodiment of the present invention;

FIG. 8 shows a block diagram of an imaging apparatus, a second embodiment of the present invention;

FIG. 9 illustrates detection of surreptitious movie recording;

FIG. 10 illustrates a relation between movie frames and video recording fields in the NTSC standards;

FIG. 11 illustrates change in field average luminance over video recording fields in surreptitious video recording in the NTSC standards;

FIG. 12 illustrates a relation between movie frames and video recording fields in the PAL standards;

FIG. 13 illustrates change in field average luminance over video recording fields in surreptitious movie recording in the PAL standards;

FIG. 14 illustrates movie frames and video recording fields at the lowest ratio of average luminance in periods Ts1 and Ts2 in the NTSC standards;

FIG. 15 illustrates movie frames and video recording fields at the lowest ratio of average luminance in periods Ts1 and Ts2 in the PAL standards;

FIG. 16 shows a flowchart for explaining the function of the imaging apparatus for prevention of surreptitious movie recording, in the second embodiment of the present invention;

FIG. 17 shows a block diagram of an imaging apparatus, a third embodiment of the present invention;

FIG. 18 illustrates change in average luminance over video recording fields in normal video recording;

FIG. 19 illustrates a relation between movie frames and the number of frames for luminance measurements;

FIG. 20 also illustrates a relation between movie frames and the number of frames for luminance measurements;

FIG. 21 illustrates change in average luminance in surreptitious movie recording at 40 in the number of frames for luminance measurement per second;

FIG. 22 illustrates change in average luminance in surreptitious movie recording at 60 in the number of frames for luminance measurement per second;

FIG. 23 illustrates change in average luminance in surreptitious movie recording at 120 in the number of frames for luminance measurement per second;

FIG. 24 shows a flowchart for explaining the function of the imaging apparatus for prevention of surreptitious movie recording, in the third embodiment of the present invention;

FIG. 25 illustrates luminance measuring periods;

FIG. 26 shows a block diagram of a reproducing apparatus, a forth embodiment of the present invention; and

FIG. 27 shows a block diagram of a reproducing apparatus, a fifth embodiment of the present invention.

### DETAILED DESCRIPTION OF PREFERRED EMBODIMENTS

Several preferred embodiments according to the present invention will be disclosed.

In the disclosure, the following two terms are defined as follows:

“surreptitious video recording”: secretly recording a movie at a theater without authorization, aiming for copyright piracy; and

“normal video recording”: recording an object, such as, a person and scenery, for private use.

### First Embodiment

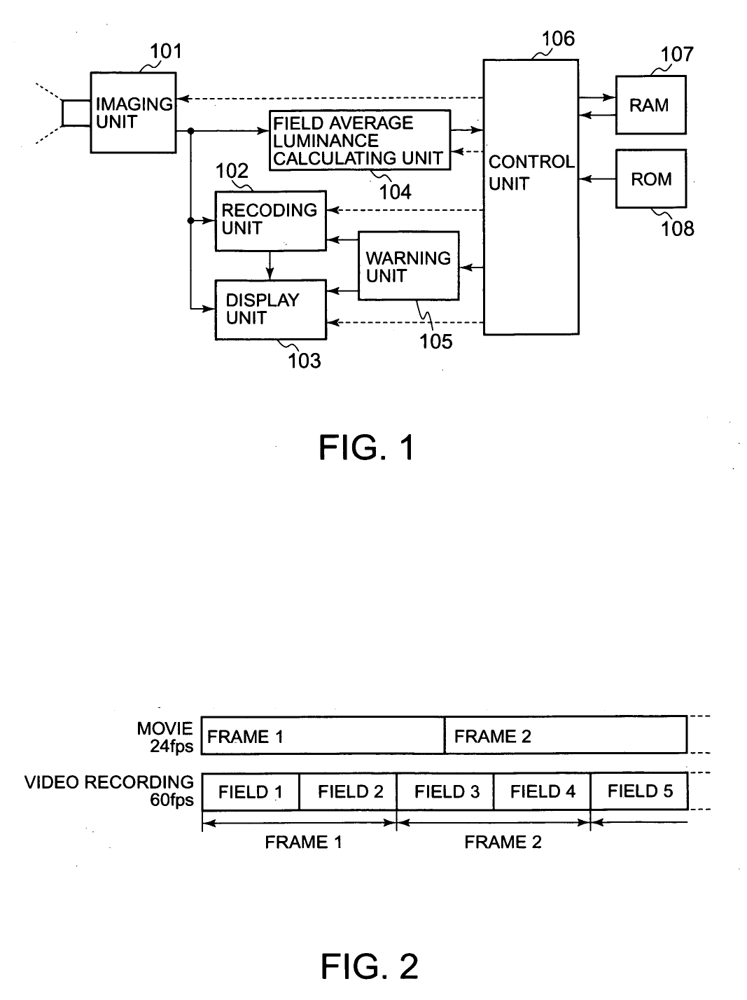

Disclosed first with reference to FIG. 1 is an imaging apparatus that is a first embodiment of the present invention.

The imaging apparatus shown in FIG. 1 is provided with an imaging unit 101, a recording unit 102, a display unit 103, a field average luminance calculating unit 104, a warning unit 105, a control unit 106, a RAM 107, and a ROM 108.

The imaging unit 101 takes images of an object and converts them into electrical signals. The unit 101 also has optical functions, such as, lens focusing to the object. The recording unit 102 records the images on storage media, such as, a magnetic tape, an HDD, a magnetic disc, a memory, and an optical disc. Moreover, the unit 102 erases the recorded data under control by the control unit 106. The display unit 103 displays images taken by the imaging unit 101, information necessary for imaging such as time, or images recorded by the recording unit 102. The field average luminance calculating unit 104 calculates field average luminance per field of the images taken by the imaging unit 101. The warning unit 105 sends a warning signal to the display unit 103 for displaying a warning message. The message is sent to the recording unit 102 and recorded as superimposed on the images, when the control unit 106 detects surreptitious video recording as disclosed below.

In addition to overall control of procedures, such as, imaging and recording, the control unit 106 has the function of detecting surreptitious video recording according to default values set in the ROM 108. The default values are a luminance ratio Ylim, the number of detection Kmax, and the number of fields for processing Fmax, which will be explained later. Temporarily stored in the RAM 107 are field average luminance values calculated for 5 fields, a detected number of detection K, and a detected number of fields for processing F. The RAM 107 is used as a working area in processing.

Disclosed next with reference to FIGS. 2 to 6 is how the control unit 106 determines video recording now performed is normal recording or surreptitious recording.

The control unit 106 has the function of detecting surreptitious video recording, as disclosed above. However, the imaging apparatus may be equipped with a detecting unit (not shown in FIG. 1) having the surreptitious video-recording detecting function which will be disclosed with reference to FIGS. 2 to 6. In this case, the control unit 106 has the function of overall control of procedures, such as, imaging and recording, with no surreptitious video-recording detecting function.

Illustrated in FIG. 2 is a relation between frames of a movie and fields to be recorded (video recording fields) by an NTSC imaging apparatus. As shown in FIG. 2, a movie has 24 fps (24 frames per second) while an image taken by an NTSC imaging apparatus is processed as having 60 fps (60 fields per second that is equal to 30 frames per second). Thus, 2 frames of a movie and 5 fields (video recording fields) of images taken have the same period length.

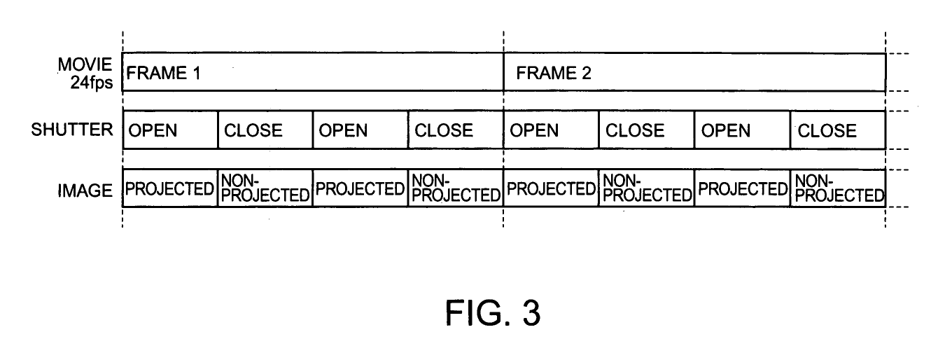

Illustrated in FIG. 3 is how a movie is projected onto a screen. A movie film consists of 24 frames per second. Projection of a movie with such number of frames at 24 times of bright and dark displaying causes unbearable flickers to the audience. Such flickers are reduced by the following technique: equally dividing one frame of an image into four segments; and feeding the movie film with shutter control so that the first segment is projected, the second segment is not projected, the third segment is projected, and then the fourth segment is not projected, as if 48 frames are projected per second. This technique provides 4 periods of non-projection periods in projection of two frames. Thus, when a movie is recorded by an NTSC imaging apparatus, 5 fields of recorded images include 4 non-projection (or non-recording) periods, according to the illustration of FIG. 2.

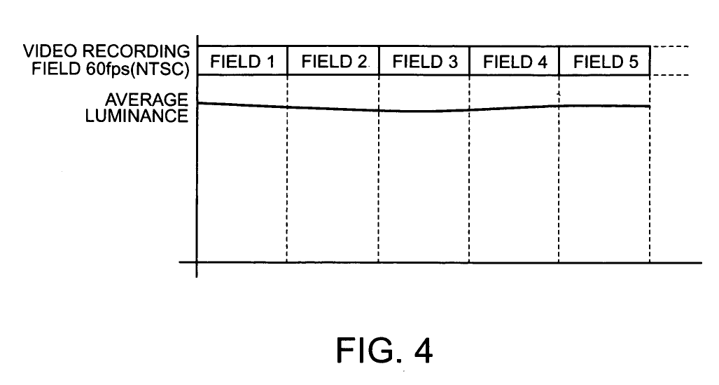

Illustrated in FIG. 4 is change in field average luminance over fields in normal video recording. As shown in FIG. 4, change in average field luminance is very small for recorded fields of continuous images when an object, such as, a person and scenery, is recorded in normal video recording. It is very rare that images of large luminance change are recorded when such an objected is recorded. Moreover, it can be said that such images of large luminance change never last longer.

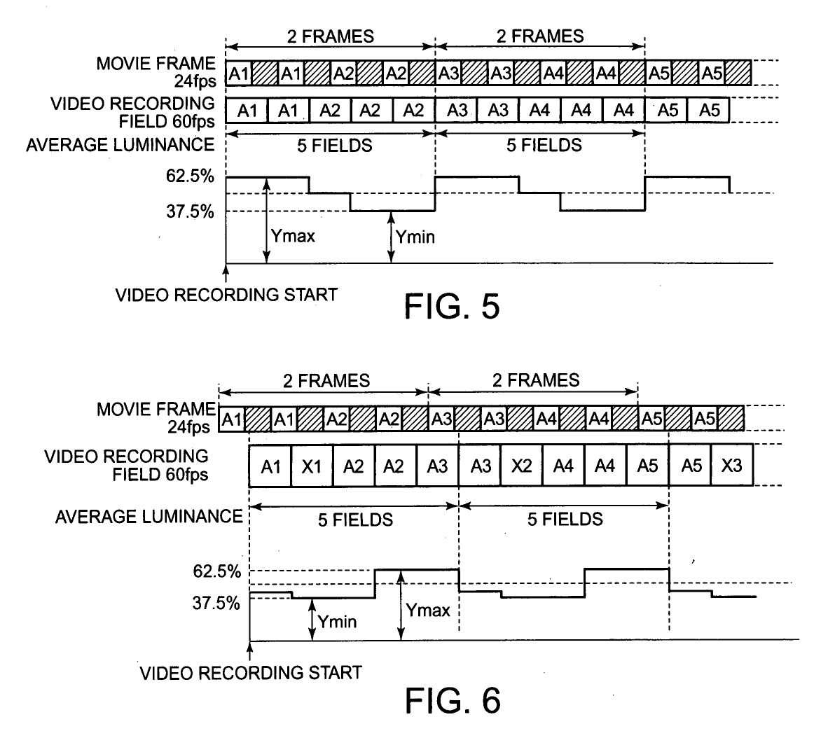

Illustrated in FIG. 5 is a first change mode in field average luminance over several fields in surreptitious video recording. Average luminance per field (field average luminance) is shown for video recording that starts at the same time as a movie starts (projection of movie frames starts).

Signs A1 to A5 shown in MOVIE FRAME represent frames of a movie. The same signs A1 to A5 also shown in VIDEO RECORDING FIELD denote that the movie frames A1 to A5 are now under video recording. Field average luminance is shown as constant for the movie frames A1 to A5 when video-recorded, based on the assumption that there is almost no big difference in field average luminance for movie frames adjacent to one another except for scene change.

White-colored sections and oblique-line sections in MOVIE FRAME in FIG. 5 represent projection- and non-projection periods, respectively, which is also applied to the other similar drawings.

In each of the first and second video recording fields (the leftmost two video recording fields), video recording covers the entire projection period for the movie frame A1 and also a portion of a non-projection period. A field average luminance in each of the first and second video recording fields in video recording covering the projection and non-projection periods becomes 62.5% against 100% for video recording if performed for each video recording field with no non-projection period, according to the ratio of the (white-colored) projected section (movie frame A1) to the (oblique-line) non-projected section. The field average luminance of 62.5% is the maximum (Ymax) over the succeeding 5 video recording fields.

In contrast, video recording covers the entire non-projection period in each of the fourth and fifth video recording fields that follow the second video recording field with the in-between third video recording field in VIDEO RECORDING FIELD. A field average luminance in each of the fourth and fifth video recording fields in video recording covering the entire non-projection periods becomes 37.5% against 100% for video recording if performed for each video recording field with no non-projection period, according to the ratio of the projected section (movie frame A2) to the non-projected section. The field average luminance of 37.5% is the minimum (Ymin) over the succeeding 5 video recording fields.

In the third field next to the second video recording field in VIDEO RECORDING FIELD, video recording covers the half of both of the projection and non-projection periods, thus giving 50% to field average luminance.

As discussed above with reference to FIG. 5, the field average luminance for video-recorded fields exhibits a large change.

Illustrated in FIG. 6 is a second change mode in field average luminance over several fields in surreptitious video recording. Average luminance per field (field average luminance) is shown for video recording that delays after a movie starts (projection of movie frames starts). The signs A1 to A5 in MOVIE FRAME and VIDEO RECORDING FIELD represent the same meaning as in FIG. 5. Signs X1, X2 and X3 in VIDEO RECORDING FIELD represent that movie frames A1 and A2, A3 and A4, and A5 and A6 (not shown), respectively, are video-recorded for the corresponding video recording field. Field average luminance is shown as constant for these movie frames, in same way as in FIG. 5.

Video recording covers the entire non-projection period in the second video recording field from the leftmost in VIDEO RECORDING FIELD, which gives the minimum field average luminance Ymin of 37.5% over the succeeding 5 video recording fields.

In contrast, video recording covers the entire projection period in each of the fourth and fifth video recording fields from the leftmost in VIDEO RECORDING FIELD, which gives the maximum field average luminance Ymax of 62.5% over the succeeding 5 video recording fields.

The maximum and minimum average field luminance are given according to the same reason as explained with reference to FIG. 5.

Two change modes in field average luminance over video recording fields in surreptitious video recording are discussed above with respect to FIGS. 5 and 6 in which video recording starts at the same time as and delays after a movie starts (projection of movie frames starts), respectively.

It is clear from FIGS. 5 and 6 that, in any timing of video recording, there is at least one video recording field for which video recording covers the entire projection period and also at least one video recording field for which video recording covers the entire non-projection period, in the succeeding 5 video recording fields.

Therefore, the field average luminance has the minimum and maximum field average luminance Ymin and Ymax over the succeeding 5 video recording fields due to existence of the entire non-projection period, except for video recording fields for which recording is performed at scene change, for example. The ratio of Ymax to Ymin is 1.67(62.5/37.5). Such a high ratio is given to each group of succeeding 5 video recording fields. However, it can be said that such large luminance change never occur in normal video recording of persons, scenery, etc, as already discussed.

The change in field average luminance discussed above teaches that surreptitious video recording of a movie in a theater can be detected with calculation of the ratio of the maximum to minimum field average luminance Ymax to Ymin over the succeeding 5 video recording fields.

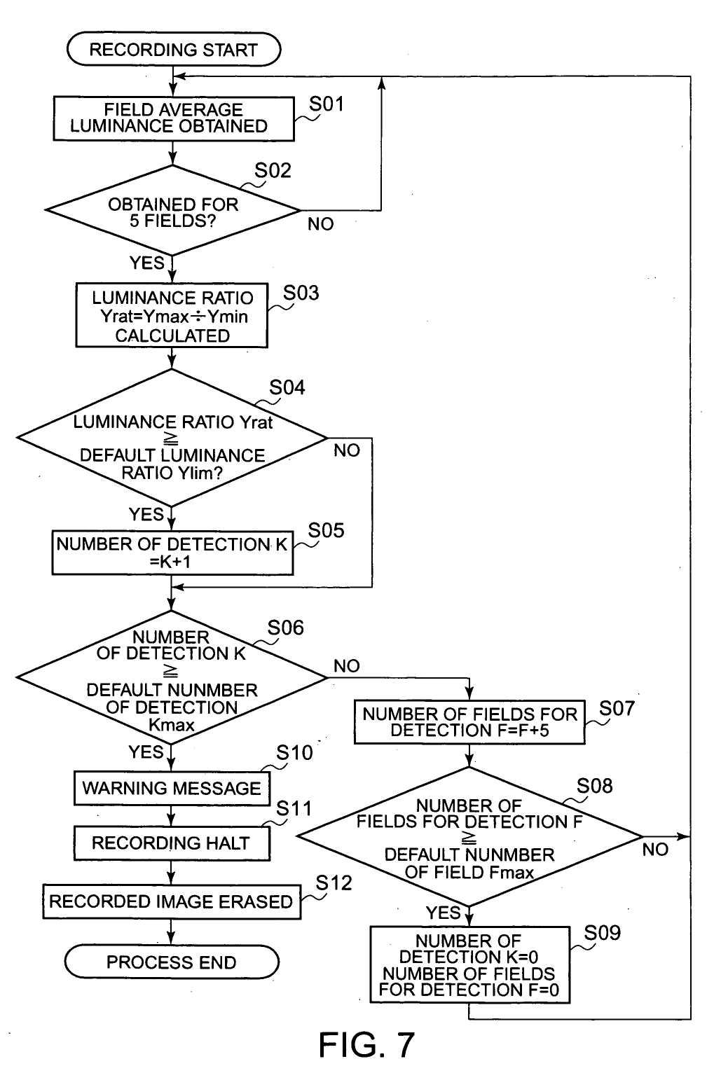

Disclosed next with reference to FIG. 7 is how the imaging apparatus shown in FIG. 1 functions in detection of surreptitious video recording of a movie in a theater.

When video recording starts, the field average luminance calculating unit 104 obtains field average luminance per video recording field, in step S01.

The control unit 106 detects the maximum field average luminance (Ymax) and the minimum field average luminance (Ymin) among succeeding 5 video recording fields and obtains a luminance ratio Yrat(Ymax/Ymin), in steps S02 and S03.

Preset in the ROM 108 as a default average field luminance ratio Ylim is, for example, 1.5 that is smaller than 1.67(62.5/37.5) over succeeding 5 video recording fields, at which surreptitious video recording of a movie in a theater can be detected, as discussed above. The value of 1.5 is set under consideration that the maximum and minimum field average luminance (Ymax) and (Ymin) could vary due to external light that affects the luminance of a projected movie.

The control unit 106 determines whether the luminance ratio Yrat otained in steps S02 and S03 is equal to or larger than the default field average luminance ratio Ylim, in step S04. If YES in step S04, the control unit 106 counts up the number of detection K, in step S05.

The control unit 106 determines whether the number of detection K is equal to or larger than a default number of detection Kmax also preset in the ROM 108, in step S06.

If YES in step S06, the control unit 106 instructs the warning unit 105 to send a warning signal to the display unit 103 for displaying a warning message for a preset period, the message being sent to the recording unit 102 and recorded as superimposed on recorded images, in step S10.

Then, the control unit 106 stops video recording irrespective of user's intention, in step S11, and erases the recorded images, in step S12.

A warning message displayed on the display unit 103 makes a user realize that surreptitious video recording is detected and recording is halted. Recording of the warning message as superimposed on recorded images, even though recording is halted, makes the quality of recorded images deteriorate even though a storage medium, such as, a magnetic tape, an optical disc, etc., are quickly detached from the imaging apparatus, thus preventing surreptitious video recording on storage media from which data cannot be erased instantaneously.

If NO in step S06, or when the number of detection K is smaller than the default number of detection Kmax, the value of is added to the number of fields for detection F, in step S07.

Then, the control unit 106 determines whether the number of fields for detection F is equal to or larger than a default number of fields Fmax also preset in the ROM 108, in step S08. If YES in step S08, the control unit 106 sets 0 to the number of detection K and also the number of fields for detection F, in step S09, and the process returns to step S01. If NO in step S08, or when the number of fields for detection F is smaller than the default number of fields Fmax, the process returns to step S01 to continue the surreptitious video-recording detection procedure.

Explained next are the default number of detection Kmax and the default number of fields Fmax.

Erroneous detection of surreptitious video recording could occur due to interference such as change in luminance of images of a movie when surreptitious recording is performed for a relatively short time. Erroneous detection is, however, preventable with a certain length of detection period due to a very low probability that such interference lasts longer. Nevertheless, such a certain length of detection period allows surreptitious recording during detection, or the longer the detection period, the more allowing surreptitious recording.

Accordingly, a suitable detection period ranges from several to several ten minutes. A detection period of, for example, 10 minutes gives 36,000 fields to the default number of fields Fmax(=60 fields/sec×60 sec×10 min).

In the first embodiment with 5 succeeding video recording fields for one procedure of surreptitious video-recording detection, the default number of fields Fmax of 36,000 gives 7,200(=36,000/5) times to the number of detection during the detection period. The number of, for example, 3,600(=7,200/2) is set to the default number of detection Kmax. It is then determined that surreptitious video recording is performed when a detected field average luminance ratio is equal to or higher than the default field average luminance ratio Ylim.

The first embodiment is disclosed so far with the default number of fields Fmax and the default number of detection Kmax in the flowchart of FIG. 7. The numbers may, however, be varied for each video recording. Moreover, the number of succeeding video recording fields for one procedure of surreptitious video-recording detection is set at 5 in FIG. 7. Any number of succeeding video recording fields may, however, be set as long as the number allows detection of the minimum and maximum field average luminance Ymin and Ymax.

### Second Embodiment

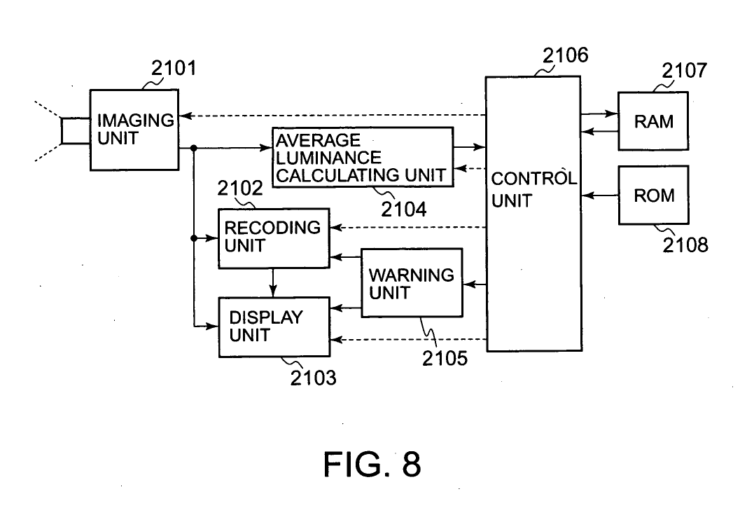

Disclosed next with reference to FIG. 8 is an imaging apparatus that is a second embodiment of the present invention.

The imaging apparatus shown in FIG. 8 is provided with an imaging unit 2101, a recording unit 2102, a display unit 2103, an average luminance calculating unit 2104, a warning unit 2105, a control unit 2106, a RAM 2107, and a ROM 2108.

The imaging unit 2101 takes images of an object and converts them into electrical signals. The unit 2101 also has optical functions, such as, lens focusing to the object. The recording unit 2102 records the images on storage media, such as, a magnetic tape, an HDD, a magnetic disc, a memory, and an optical disc. Moreover, the unit 2102 erases the recorded data under control by the control unit 2106. The display unit 2103 displays images taken by the imaging unit 2101, information necessary for imaging such as time, or images recorded by the recording unit 2102. The average luminance calculating unit 2104 calculates average luminance of the images taken by the imaging unit 2101, and also average luminance with field division. The warning unit 2105 sends a warning signal to the display unit 2103 for displaying a warning message. The message is sent to the recording unit 2102 and recorded as superimposed on the images, when the control unit 2106 detects surreptitious video recording as disclosed below.

In addition to overall control of procedures, such as, imaging and recording, the control unit 2106 has the function of detecting surreptitious video recording according to default values set in the ROM 2108. The default values are a luminance ratio Ylim, the number of detection Kmax, and the number of fields Fmax, which will be explained later. Temporarily stored in the RAM 2107 are calculated average luminance for periods Ts1 and Ts2, a detected number of detection K, and a detected number of fields for processing F. The RAM 2107 is used as a working area in processing.

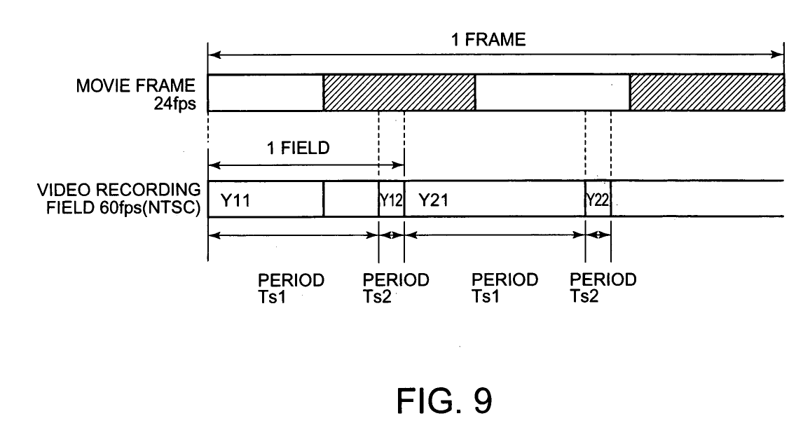

Disclosed next with reference to FIGS. 9 to 13 is how the control unit 2106 determines video recording now performed is normal recording or surreptitious recording.

The control unit 2106 has the function of detecting surreptitious video recording, as disclosed above. However, the imaging apparatus may be equipped with a detecting unit (not shown in FIG. 8) having the surreptitious video-recording detecting function which will be disclosed with reference to FIGS. 9 to 13. In this case, the control unit 2106 has the function of overall control of procedures, such as, imaging and recording, with no surreptitious video-recording detecting function.

The basic concept for the second embodiment is the same as the first embodiment as discussed with reference to FIG. 4. Specifically, change in luminance is very small for recorded fields of continuous images when an object, such as, a person and scenery, is recorded in normal video recording.

Illustrated in FIG. 9 is detection of surreptitious video recording under the NTSC standards. One video recording field is divided into periods Ts1 and Ts2 (Ts1>Ts2). Average luminance is obtained for each period at the average luminance calculating unit 2104. The images taken for the period Ts1 are used for video recording whereas those taken for the period Ts2 are used only for detection of surreptitious video recording. The ratio of the periods Ts1 to Ts2 is set at 9:1 in FIG. 9. A longer Ts2 causes decrease in luminance of images taken for Ts1.

In FIG. 9, each of signs Y11 and Y12 represents average luminance per unit of time for the first video recording field, the same for signs Y21 and Y22 for the second video recording field. As discussed with reference to FIG. 3, there are two non-projection periods for one movie frame. Thus, Y11 is larger than Y12 whereas Y21 is smaller than Y22, in FIG. 9. Comparison of the average luminance between the periods Ts1 and Ts2 for each video recording field thus allows detection of surreptitious video recording.

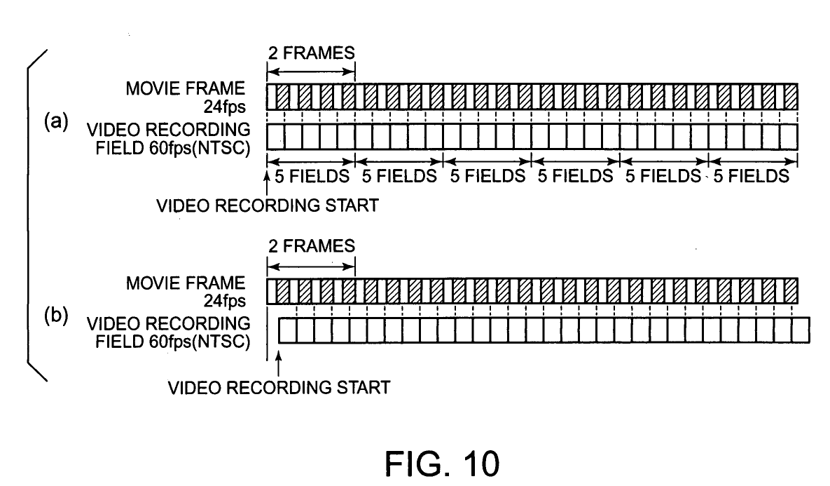

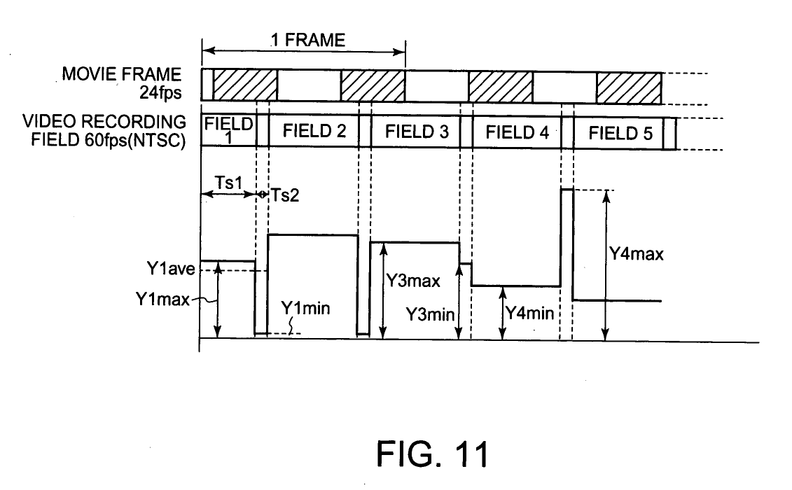

Illustrated in FIGS. 10 and 11 is a relation between movie frames and video recording fields in the NTSC standards, and change in field average luminance over several video recording fields in surreptitious video recording in the NTSC standards, respectively.

As shown in (a) of FIG. 10, when a movie of 24 fps (frames per second) is vide-recorded by an NTSC imaging apparatus at 60 fps (60 fields per second), 2 movie frames are recorded for 5 video recording fields (the 2 movie frames being equal to the 5 video recording fields in time).

Thus, as shown in FIG. 11, any of non-projected periods does not synchronize with video recording fields. This results in a big difference in average luminance in the periods Ts1 and Ts2 over several video recording fields.

Specifically, in a video recording field 1, average luminance (Y1max) in the period Ts1 is much larger than average luminance (Y1min) in the period Ts2. In a video recording field 4, average luminance (Y4min) in the period Ts1 is much smaller than average luminance (Y4max) in the period Ts2. Thus, video recording of a movie of 24 fps gives a high ratio of average luminance in the video recording fields 1 and 4. And, such a high ratio can not be given in normal video recording of persons, scenery, etc, as already discussed. Different from them, in a video recording field 3, a ratio of average luminance Y3max to Y3min is relatively small for the periods Ts1 and Ts2. Therefore, it can not be said that a high ratio of average luminance is always given over several video recording fields.

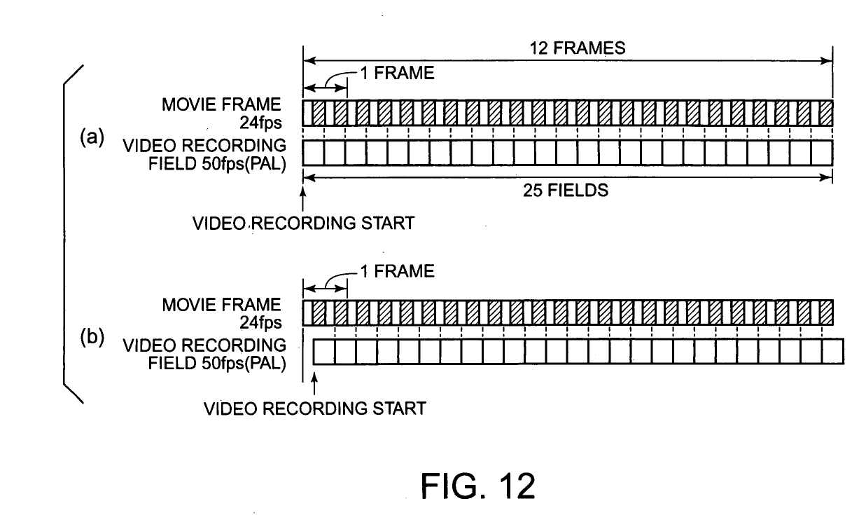

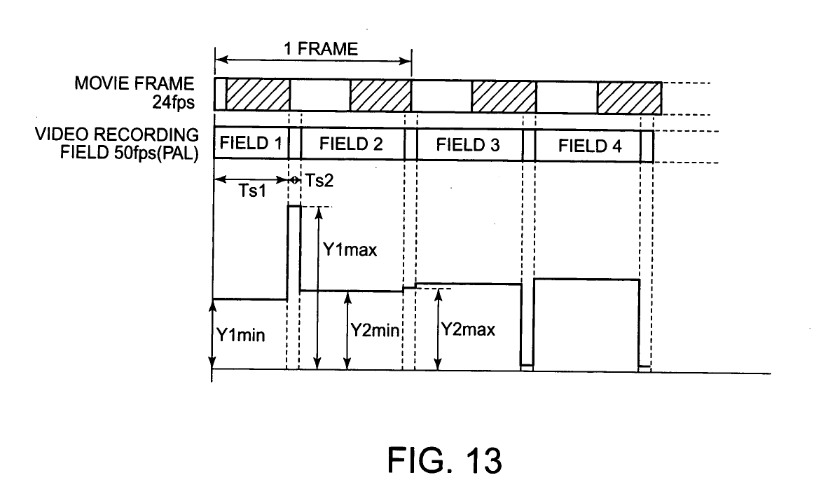

Illustrated in FIGS. 12 and 13 are a relation between movie frames and video recording fields in the PAL standards, and change in field average luminance over several video recording fields in surreptitious video recording in the PAL standards, respectively.

As shown in (a) of FIG. 12, when a movie of 24 fps is vide-recorded by a PAL imaging apparatus at 50 fps, 12 movie frames are recorded for 25 video recording fields (the 12 movie frames being equal to the 25 video recording fields in time).

Thus, as shown in FIG. 13, any of non-projected periods does not synchronize with video recording fields. This results in a big difference in average luminance in the periods Ts1 and Ts2 over several video recording fields, like in the NTSC standards.

Specifically, in a video recording field 1, average luminance (Y1min) in the period Ts1 is much smaller than average luminance (Y1max) in the period Ts2. Thus, video recording of a movie of 24 fps give a high ratio of average field luminance in the video recording field 1. And, such a high ratio can not be given in normal video recording of persons, scenery, etc, as already discussed. Different from that, in a video recording field 2, a ratio of average luminance Y2max to Y2min is relatively small for the periods Ts1 and Ts2. Therefore, it can not be said that a high ratio of average luminance is always given over several video recording fields, like in the NTSC standards.

Illustrated in (b) of FIGS. 10 and 12 is that video recording delays after a movie starts (projection of movie frames starts).

Accordingly, there are 3 modes of video recording start timing as listed below when a movie of 24 fps is recorded by an NTSC imaging apparatus at 60 fps or also a PAL imaging apparatus at 50 fps, with reference to FIGS. 11 and 13.

(a) Video recording covers the non-projection period for the entire period Ts2.

(b) Video recording covers the projection and non-projection periods for the period Ts2.

(c) Video recording covers the projection period for the entire period Ts2.

The mode (a) gives vary small average luminance to the period Ts2, thus giving a high ratio of average luminance to the periods Ts1 and Ts2, resulting in easier detection of surreptitious video recording.

The mode (b) gives fairly same average luminance to the periods Ts1 and Ts2, thus giving a lower ratio of average luminance than the mode (a), to the periods Ts1 and Ts2, resulting in difficult detection of surreptitious video recording.

The mode (c) gives a lower ratio of average luminance than the mode (a) whereas a higher ratio than the mode (b), to the periods Ts1 and Ts2.

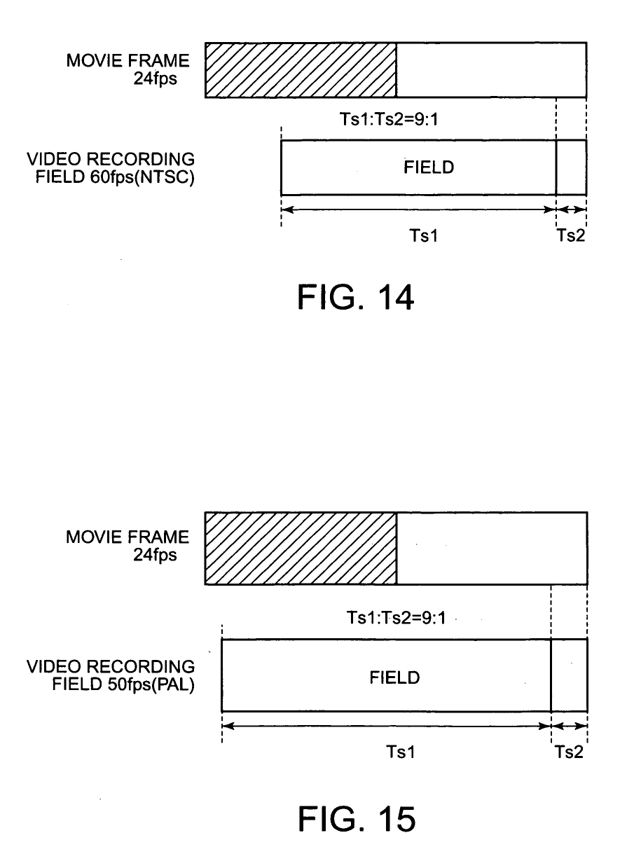

Moreover, the mode (c) gives the lowest ratio of average luminance to the periods Ts1 and Ts2 when movie frames and video recording fields have such a timing relation as illustrated in FIG. 14 in the NTSC standards and also FIG. 15 in the PAL standards.

Accordingly, an appropriate default luminance ratio Ylim(Ymax/Ymin) is required to be set in order to detect surreptitious video recording even in the conditions such as illustrated in FIGS. 14 and 15.

The average luminance in the period Ts1 is 58.3% and 46.8% for the NTSC and PAL standards, respectively, against 100% in the period Ts2 at the ratio of 9:1 to the periods Ts1 and Ts2 (as shown in FIG. 9). Thus, the default luminance ratios Ylim(Ymax/Ymin) of 1.71 and 2.13 allow detect surreptitious video recording in the NTSC and PAL standards, respectively. In practice, however, the ratio Ylim is set at a smaller value, such as, 1.5 and 1.9 in the NTSC and PAL standards, respectively, which allow detection of surreptitious video recording against interference such as change in luminance of images of a movie.

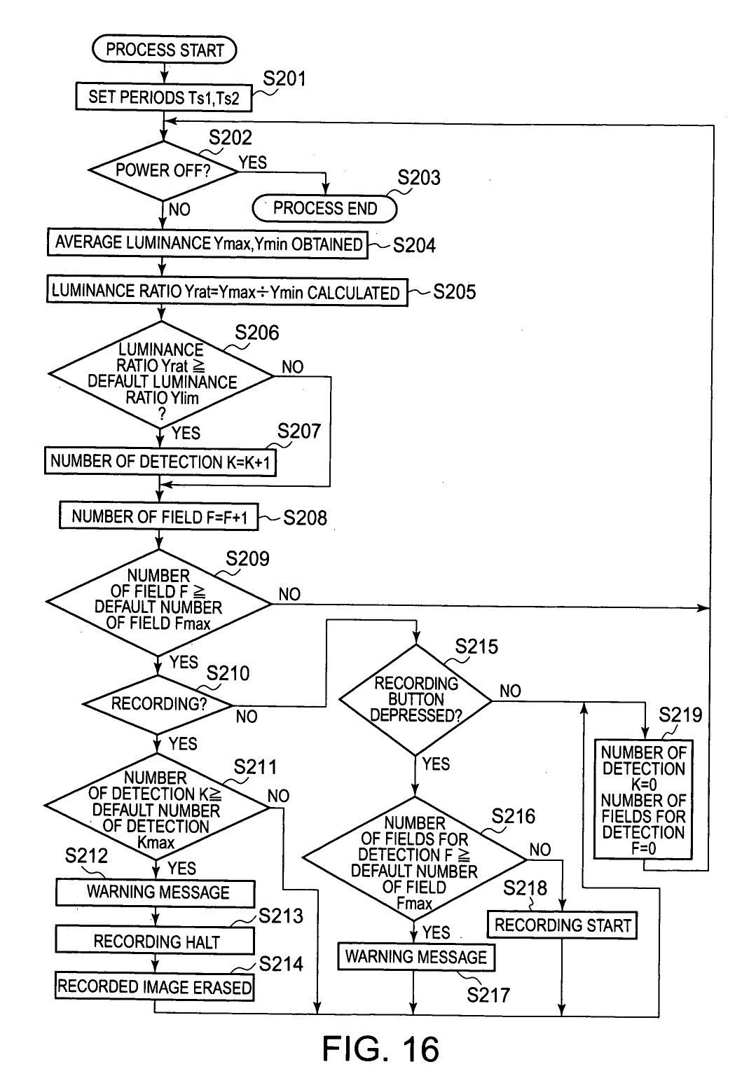

Disclosed next with reference to FIG. 16 is how the imaging apparatus shown in FIG. 8 functions in detection of surreptitious video recording of a movie in a theater.

When the imaging apparatus is power on, the average luminance calculating unit 104 obtains average luminance from images taken per video recording field, and the control unit 2106 sets sampling periods Ts1 and Ts2 based on the average luminance, in step S201. The control unit 2106 determines whether a power button is depressed to power off the imaging apparatus, in step S201. If YES in step S202, the process ends.

If NO in step S202, the average luminance calculating unit 104 obtains the maximum average luminance (Ymax) and the minimum average luminance (Ymin) for the periods Ts1 and Ts2 per video recording field and calculates an average luminance ratio Yrat(Ymax/Ymin), in steps S205.

The control unit 2106 determines whether the calculated average luminance ratio Yrat(Ymax/Ymin) is equal to or larger than a default average luminance ratio Ylim preset in the ROM 2108, in steps S206.

If YES in step S206, the control unit 2106 counts up the number of detection K, in step S07. The control unit 2106 also counts up the number of fields for processing F, in step S208. The control unit 2106 determines whether the number of fields for processing F is equal to or larger than a default number of fields for processing Fmax preset in the ROM 2108, in step S209.

If YES in step S209, the control unit 2106 determines whether video recording is being performed, in step S210. If NO in step S209, the process returns to step S202 for the next average field luminance detection.

If YES in step S210, the control unit 2106 determines whether the number of detection K is equal to or larger than a default number of detection Kmax preset in the ROM 2108, in step S211.

If YES in step S211, the control unit 2106 instructs the warning unit 2105 to send a warning signal to the display unit 2103 for displaying a warning message for a preset period, the message being sent to the recording unit 2102 and recorded as superimposed on recorded images, in step S212.

Then, the control unit 2106 stops video recording irrespective of user's intention, in step S213, and erases the recorded images, in step S214.

A warning message displayed on display unit 2103 makes a user realize that surreptitious video recording is detected and recording is halted. Recording of the warning message as superimposed on recorded images, even though recording is halted, makes the quality of recorded images deteriorate even though a storage medium, such as, a magnetic tape, an optical disc, etc., are quickly detached from the imaging apparatus, thus preventing surreptitious video recording on storage media from which data cannot be erased instantaneously.

If NO in step S210, or video recording is not being performed, The control unit 2106 determines whether a video recording button is depressed, in step S215.

If YES in step S215, the control unit 2106 determines whether the number of detection K is equal to or larger than the default number of detection Kmax preset in the ROM 2108, in steps S216. If YES in step S216, the control unit 2106 instructs the warning unit 2105 to send a warning signal to the display unit 2103 for displaying a warning message that video recording is prohibited, for a preset period, in step S217. If NO in step S216, the control unit 2106 starts video recording, in step S218, and then resets the number of detection K and the number of fields for processing F to 0, in step S219. The process returns to step S202 for the next average field luminance detection.

If NO in step S215, or the video recording button is not depressed, the process goes to step S219 and then returns to step S202 for the next average field luminance detection.

As discussed in the first embodiment, erroneous detection of surreptitious video recording could occur due to interference such as change in luminance of images of a movie when surreptitious recording is performed for a relatively short time. Erroneous detection is preventable with a certain length of detection period due to a very low probability that such interference lasts longer. Nevertheless, such a certain length of detection period allows surreptitious recording during detection, the longer the detection period, the more allowing surreptitious recording.

Accordingly, a suitable detection period ranges from several to several ten minutes. A detection period of, for example, 10 minutes gives 36,000 fields to the default number of fields Fmax(=60 fields/sec×60 sec×10 min).

In the second embodiment with one video recording field for one procedure of surreptitious video-recording detection, the default number of fields Fmax of 36,000 gives 36,000(=36,000/1 field) times to the number of detection during the detection period. The number of, for example, 18,000(=36,000/2) is set to the default number of detection Kmax. It is then determined that surreptitious video recording is performed when a detected average luminance ratio is equal to or higher than the default average field luminance ratio Ylim at or beyond the default number of detection Kmax.

The second embodiment is disclosed so far with the default number of fields Fmax and the default number of detection Kmax in the flowchart of FIG. 16. The numbers may, however, be varied for each video recording. Moreover, although the second embodiment is disclosed so far for video recording of a movie of 24 fps (frames per second) at 60 or 50 fps (video recording fields per second), these number of frames and fields may be any number according to the present invention.

Still, furthermore, in the second embodiment, one recording field is divided into to two segments and the ratio of average luminance is obtained from the average luminance in the two segments. One recording field may, however, be divided into three segments or more.

Moreover, the ratio of average luminance may not be obtained from one video recording field but from: the average luminance in one video recording field and the average luminance in another video recording field; the average luminance in one video recording field and the average luminance in a portion of another video recording field; or the average luminance in a portion of one video recording field and the average luminance in a portion of another video recording field.

Steps S204 to S206 of the flowchart in FIG. 16 may be modified as follows: Average luminance Y1ave for the entire periods Ts1 and Ts2 (for example, for the video recording field 1 in FIG. 11) is obtained by the average luminance calculating unit 2104. Then, the control unit 2106 determines whether either of the following two requirements is met: (1) the average luminance in the period Ts1 is equal to or smaller than Y1ave and the average luminance in the period Ts2 is equal to or larger than Y1ave; and (2) the average luminance in the period Ts1 is equal to or larger than Y1ave and the average luminance in the period Ts2 is equal to or smaller than Y1ave.

Moreover, in the second embodiment, one video recording field is divided into the periods Ts1 and Ts2 (Ts1>Ts2), images taken for the period Ts1 being used for recording whereas images taken for the period Ts2 being used only for detection of surreptitious video recording. It may, however, also be feasible that imaging is performed for the entire one video recording field and the average luminance is obtained from the periods Ts1 and Ts2 of the video recording field.

### Third Embodiment

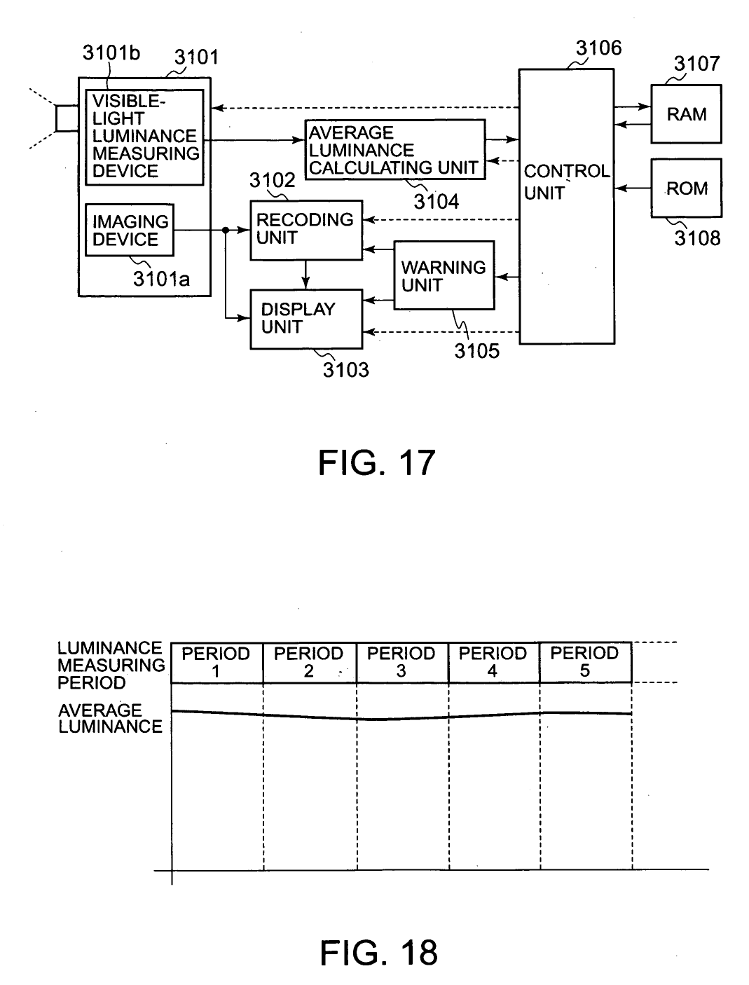

Disclosed first with reference to FIG. 17 is an imaging apparatus that is a third embodiment of the present invention.

The imaging apparatus shown in FIG. 17 is provided with an imaging unit 3101, a recording unit 3102, a display unit 3103, an average luminance calculating unit 3104, a warning unit 3105, a control unit 3106, a RAM 3107, and a ROM 3108.

The imaging unit 3101 is equipped with: an imaging device 3101a for taking images of an object; and a visible-light luminance measuring device 3101b for measuring the luminance of light from the object, for which the images are being taken, through lenses (not shown) and converting the measured luminance into electrical signals. The imaging unit 3101 converts the images taken by the imaging device 3101a into electrical signals. The unit 3101 also has optical functions, such as, lens focusing to the object.

The recording unit 3102 records the images on storage media, such as, a magnetic tape, an HDD, a magnetic disc, a memory, and an optical disc. Moreover, the unit 3102 erases the recorded data under control by the control unit 3106.

The display unit 3103 displays images taken by the imaging unit 3101, information necessary for imaging such as time, or images recorded by the recording unit 3102. The average luminance calculating unit 3104 calculates average luminance of the images taken by the visible-light luminance measuring device 3101.

The warning unit 3105 sends a warning signal to the display unit 3103 for displaying a warning message. The message is sent to the recording unit 3102 and recorded as superimposed on the images, when the control unit 3106 detects surreptitious video recording as disclosed below.

In addition to overall control of procedures, such as, imaging and recording, the control unit 3106 has the function of detecting surreptitious video recording according to default values set in the ROM 3108, and also control of the number of frames for luminance measurements. The default values are a luminance ratio Ylim, the number of detection Kmax1 and Kmax2, the number of processing Rmax, and the initial value for luminance measurements, which will be explained later. Temporarily stored in the RAM 3107 are average luminance values measured two times, a detected the number of detection K, and a detected number of processing R. The RAM 3107 is used as a working area in processing.

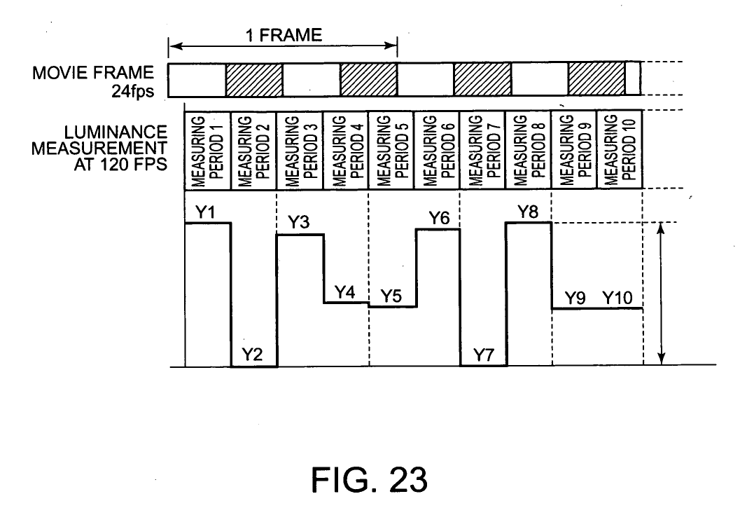

Disclosed next with reference to FIGS. 18 to 23 is how the control unit 3106 determines video recording now performed is normal recording or surreptitious recording, with periodic measurements of luminance of images taken through lenses (not shown) at the visible-light luminance measuring device 3101b.

The control unit 3106 has the function of detecting surreptitious video recording, as disclosed above. However, the imaging apparatus may be equipped with a detecting unit (not shown in FIG. 17) having the surreptitious video-recording detecting function which will be disclosed with reference to FIGS. 18 to 23. In this case, the control unit 3106 has the function of overall control of procedures, such as, imaging and recording, with no surreptitious video-recording detecting function.

Illustrated in FIG. 18 is change in average luminance of images taken through lenses (not shown) periodically measured at the visible-light luminance measuring device 3101b, in normal video recording. As shown in FIG. 18, change in average luminance is very small for recorded continuous images when an object, such as, a person and scenery, is recorded in normal video recording.

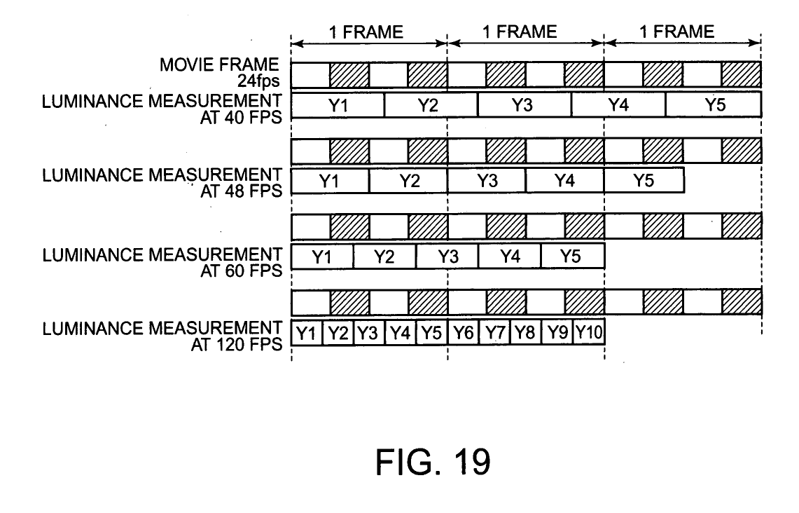

Illustrated in FIG. 19 is a relation between movie frames and the number of frames for luminance measurements. Also, in the third embodiment, average frame luminance is constant when video-recorded, based on the assumption that there is almost no big difference in average luminance for movie frames adjacent to one another except for scene change.

As shown in FIG. 19, the number of frames for luminance measurements at even multiple of 24 fps (frames per second) of a movie to be projected, such as, 48 FPS (frames per second) gives the ratio of 1:1 to the projection and non-projection periods for each measuring period, resulting in the same average luminance over measuring periods, thus detection of surreptitious video recording being impossible. The number of frames for luminance measurements closer to 48 FPS also gives a small difference in luminance over measuring periods, thus detection of surreptitious video recording being inaccurate.

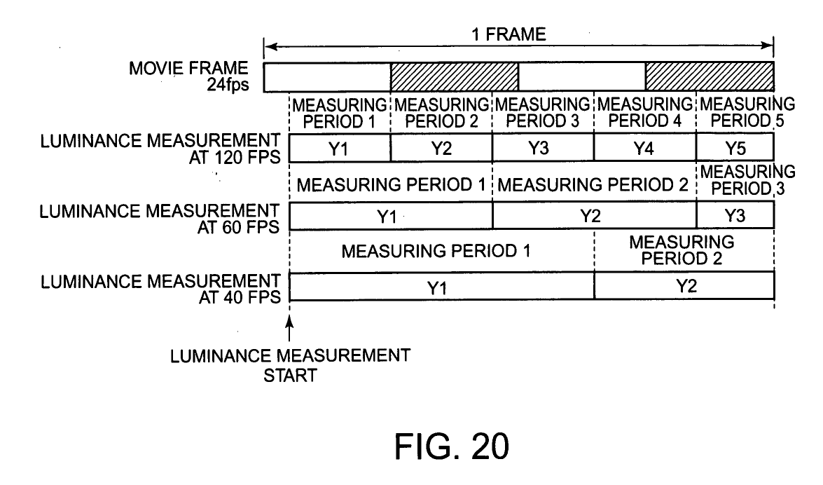

Also shown in FIG. 19 are the number of frames for luminance measurements not at even multiple of 24 FPS, such as, 40, 60 and 120 FPS that give a different ratio of the projection to non-projection periods for each measuring period, which is illustrated as enlarged in FIG. 20.

As shown in FIG. 20, the number of frames of 120 FPS for luminance measurements of movie images through lenses allows measurements for the projection period in a measuring period 1 whereas the non-projection period in a measuring period 2. The measurements in movie recording gives a much higher ratio of average luminance Y1 to Y2 for each measuring period than in normal recording.

On the contrary, in measuring periods 3 and 4, 120 FPS allows luminance measurements for both of the projection and non-projection periods. The measurements in movie recording gives a relatively low ratio of average luminance Y3 to Y4 to the measuring periods 3 and 4 having a relatively same ratio of the projection to non-projection periods.

The above discussion on 120 FPS can be applied to 40 and 60 FPS. In summary, luminance measurements for a movie at the number of frames not at even multiple of 24 fps (the number of movie frames per second) causes two situations on the ratio of average luminance in the two continuous periods: a higher ratio than in normal recording; and a roughly similar ratio as in normal recording, for two succeeding measuring periods.

Accordingly, in the third embodiment, the requirements for detection of surreptitious recording are: the ratio of average luminance for succeeding measuring periods is equal to or higher than a default value; and the number of measuring periods, for which the ratio of average luminance is equal to or higher than the default value, is equal to or larger than a default number.

The formulas (1) and (2) shown below give a feasible number of frames for luminance measurements in which M and N are selected so that they can satisfy the formulas (1) and (2), and N is larger than M. Specifically, the formulas (1) and (2) cause a big difference in timing of recording the non-projection period (a timing relation between the non-projection period and the luminance measuring period) over luminance measuring periods, which gives no same average luminance to succeeding measuring periods.

N ≠ a×M(a=1, 2, 4) (1)

(1/the number of movie frames to be projected×M)=(1/the number of frames for luminance measurements×N) (2)

M: the number of movie frames required for detection of surreptitious recording N: the number of luminance measurements per number of frames for luminance measurements (M, N being an integer)

The formulas (1) and (2) give M and N, for example, as follows:

M=3, N=5: five times of luminance measurements for three movie frames, at 40 in the number of frames for luminance measurements;

M=2, N=5: five times of luminance measurements for two movie frames, at 60 in the number of frames for luminance measurements; and

M=1, N=5: five times of luminance measurements for one movie frame, at 120 in the number of frames for luminance measurements.

The number of frames for luminance measurements of 40, 60 and 120 FPS meet the requirements discussed above. Therefore, the average luminance to be measured is discussed below for 40, 60 and 120 FPS, with reference to FIG. 19.

The number of frames for luminance measurements of 40 FPS gives the maximum average luminance to Y1 and Y2 for which over the half is the projection period whereas the minimum average luminance to Y4 and Y5 for which over the half is the non-projection period, among the average luminance Y1 to Y5.

The number of frames for luminance measurements of 60 FPS gives the maximum average luminance to Y1 and Y2 that cover the entire projection period whereas the minimum average luminance to Y4 and Y5 that cover the entire non-projection period, among the average luminance Y1 to Y5.

The number of frames for luminance measurements of 120 FPS gives the maximum average luminance to Y1 and Y6 that cover the entire projection period whereas the minimum average luminance to Y5 and Y10 that cover the entire non-projection period, among the average luminance Y1 to Y10.

As discussed above, the formulas (1) and (2) give a feasible number of frames for luminance measurements for accurate detection of surreptitious recording.

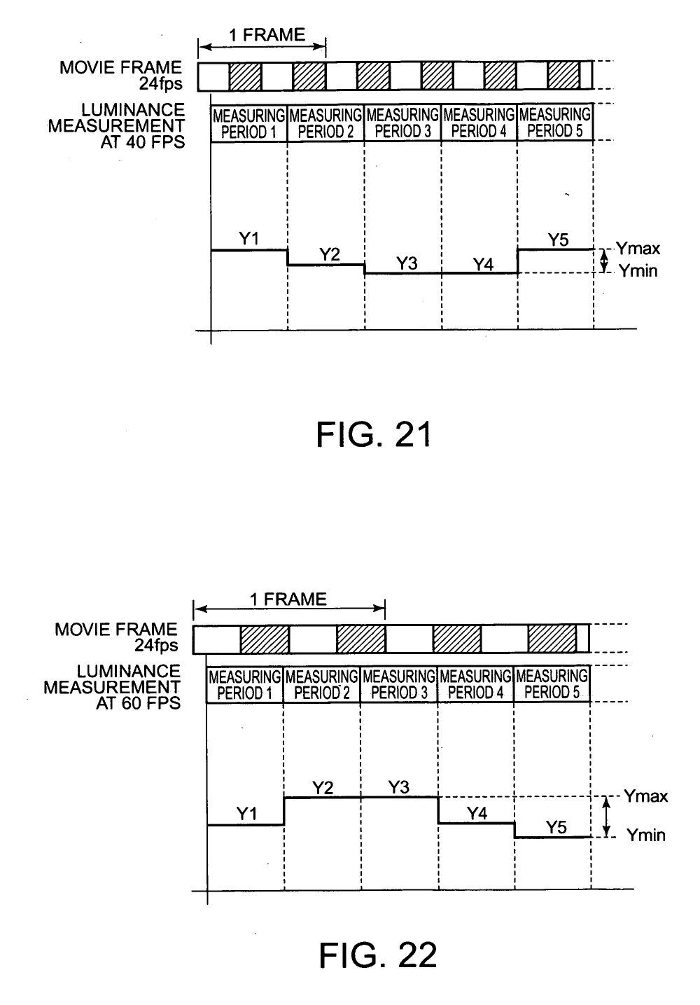

Discussed next with reference to FIGS. 21 to 23 is a relation between the number of frames for luminance measurements and change in average luminance in surreptitious video recording. Specifically, FIGS. 21 to 23 show the average luminance at 40, 60 and 120 FPS (frame per second), respectively, for the number of frames for luminance measurements.

FIGS. 21 to 23 show the larger the number of frames for luminance measurements, the higher percentage of the projection or non-projection period in the luminance measuring period, resulting in a higher ratio of the maximum to minimum average luminance in a given period (corresponding to 5 times of one luminance measuring period, in the third embodiment).

This teaches that more accurate detection of surreptitious video recording is achieved with a larger number of frames for luminance measurements. Nevertheless, a much larger number of frames for luminance measurements, or a much shorter luminance measuring period causes the imaging apparatus to consume much power due to increase in processing at the control unit 3106. Thus, it is feasible that the number of frames for luminance measurements is increased only when higher detection accuracy is required.

The number of frames for luminance measurements is increased in the third embodiment when there is a high probability of surreptitious video recording, as discussed later.

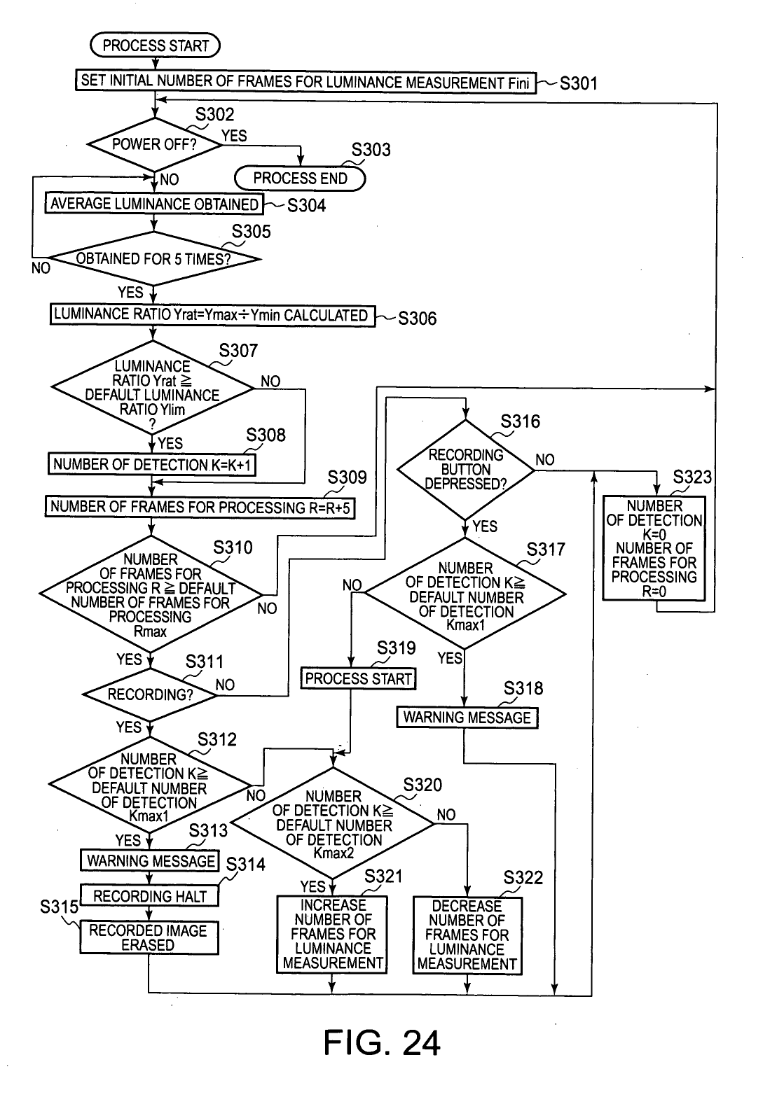

Disclosed next with reference to FIG. 24 is how the imaging apparatus shown in FIG. 17 functions in detection of surreptitious video recording of a movie in a theater.

When the imaging apparatus is power on, the control unit 3106 sets an initial number of frames for luminance measurements Fini, in step S301. Then, the control unit 32106 determines whether a power button is depressed, in step S302. If YES in step S302, the process ends.

If NO in step S302, the control unit 3106 obtains average luminance over 5-time luminance measurements according to the initial number of frames for luminance measurements Fini, through the average luminance calculating unit 3104, in step S304 and S305. The control unit 3106 calculates an average luminance ratio Yrat(Ymax/Ymin) over 5-time luminance measurements, in step S306, and determines whether the calculated average luminance ratio Yrat is equal to or larger than a default average luminance ratio Ylim preset in the ROM 3108, in steps S307. If YES in steps S307, the control unit 3106 counts up the number of detection K, in step S308.

The default average luminance ratio Ylim in the third embodiment is explained below.

Succeeding 5 luminance measuring periods in measurements at 40 FPS in the number of frames for luminance measurements always have the following luminance measuring periods (a) and (b), depending on a timing relation between the movies frames to be projected and the frames for luminance measurements:

(a) a luminance measuring period that covers one of two non-projection periods for one movie frame and the remaining all projection periods for the movie frame, thus obtaining the maximum average luminance; and

(b) a luminance measuring period that covers one of two projection periods for one movie frame and the remaining all non-projection periods for the movie frame, thus obtaining the minimum average luminance.

The average luminance are thus 58.3% and 41.7% for the periods (a) and (b), respectively, against 100% for the average luminance in measurements that covers the projection periods in the entire luminance measuring period for one movie frame.

Accordingly, surreptitious video recording can be detected when the ratio of the maximum average luminance to the minimum average luminance Yrat is 1.4(58.3%/41.7%) over succeeding 5 luminance measuring periods. In practice, however, the ratio Yrat is set at a smaller value, such as, 1.25, which allows detection of surreptitious video recording against interference such as change in luminance of images of a movie.

Following to step S308 in FIG. 24, the control unit 3106 counts up the number of frames for processing R, in step S309. The control unit 3106 determines whether the number of frames for processing R is equal to or larger than a default number of frames for processing Rmax preset in the ROM 3108, in step S310.

IF YES in step S310, the control unit 3106 determines whether recording is being performed, in step S311. IF NO in step S310, the process returns to step S302 for the next average luminance detection.

IF NO in step S311, the control unit 3106 determines whether a recording button is depressed, in step S316. If NO in step S316, the control unit 3106 resets the number of detection K and the number of frames for processing to 0, in step S323. The process returns to step S302 for the next average luminance detection.

If YES in step S316, or the recording button is depressed, the control unit 3106 determines whether the number of detection K is equal to or larger than a default number of detection Kmax1 preset in the ROM 3108, in steps S217. If YES in step S317, the control unit 3106 instructs the warning unit 3105 to send a warning signal to the display unit 3103 for displaying a warning message that video recording is prohibited, for a preset period, in step S322. If NO in step S317, the control unit 3106 starts recording, in step S319.

When NO in step S317, or it is determined that the number of detection K is smaller than the default number of detection Kmax1, there is a possibility that this determination is caused by bad video recording conditions, such as, interference, for example, change in luminance of images of a movie.

In order to avoid wrong determination in step S317, the control unit 3106 further determines, in steps S320 whether the number of detection K is equal to or larger than a default number of detection Kmax2 preset in the ROM 3108.

IF YES in steps S320, the control unit 3106 increases the number of frames for luminance detection F, in steps S321, to raise detection accuracy. IF NO in steps S320, the control unit 3106 decreases the number of frames for luminance detection F, in steps S322, for power saving, but up to the initial number of frames for luminance measurements Fini (set in step S301). Then, the control unit 3106 resets the number of detection K and the number of frames for processing to 0, in step S323. Then, the process returns to step S302 for the next average luminance detection.

If YES in step S311, or it is determined that video recording is being performed, the control unit 3106 determines whether the number of detection K is equal to or larger than the default number of detection Kmax1, in step S312.

If YES in step S312, the control unit 3106 instructs the warning unit 3105 to send a warning signal to the display unit 3103 for displaying a warning message for a preset period, the message being sent to the recording unit 3102 and recorded as superimposed on recorded images, in step S313.

Then, the control unit 3106 stops video recording irrespective of user's intention, in step S314, and erases the recorded images, in step S315.

A warning message displayed on display unit 3103 makes a user realize that surreptitious video recording is detected and recording is halted. Recording of the warning message as superimposed on recorded images, even though recording is halted, makes the quality of recorded images deteriorate even though a storage medium, such as, a magnetic tape, an optical disc, etc., are quickly detached from the imaging apparatus, thus preventing surreptitious video recording on storage media from which data cannot be erased instantaneously.

If NO in step S312, or it is determined that the number of detection K is equal to or larger than the default number of detection Kmax1, the control unit 3106 further determines, in steps S320, whether the number of detection K is equal to or larger than the default number of detection Kmax2, according to the same reason explained with respect to step S317. The process goes to step S321 or S322 and then to step S323.

Explained next are the default number of frames Rmax, and the default numbers of detection Kmax1 and Kmax2.

Erroneous detection of surreptitious video recording could occur due to interference such as change in luminance of images of a movie when surreptitious recording is performed for a relatively short time. Erroneous detection is preventable with a certain length of detection period due to a very low probability that such interference lasts longer. Nevertheless, such a certain length of detection period allows surreptitious recording during detection, the longer the detection period, the more allowing surreptitious recording.

Accordingly, a suitable detection period ranges from several to several ten minutes. A detection period of, for example, 10 minutes gives 24,000 frames to the default number of frames Rmax(=40 frames/sec×60 sec×10 min).

In the third embodiment with 5 luminance measuring periods for one procedure of surreptitious video-recording detection, the default number of frames Rmax of 24,000 gives 4,800(=24,000/5) times to the number of detection during the detection period. The number of, for example, 2,400(=4,800/2) is set to the default number of detection Kmax1. It is then determined that surreptitious video recording is performed when a detected average luminance ratio is equal to or higher than the default average luminance ratio Ylim at the number of detection K equal to or larger than Kmax1. Moreover, the number of, for example, 960(=4,800/5) is set to the default number of detection Kmax2. It is then determined that there is a high probability of surreptitious video recording being performed when a detected average luminance ratio is equal to or higher than the default average luminance ratio Ylim at the number of detection K equal to or larger than Kmax2, followed by adjustments to the number of frames for luminance measurements.

Although the third embodiment is disclosed so far for video recording of a movie of 24 fps (frames per second), the number of movie frames may be any number according to the present invention.

Moreover, in the third embodiment, the ratio of average luminance is obtained for two measuring periods in detection of surreptitious video recording. The number of measuring periods for which the ratio of average luminance is obtained may, however, be three or more.

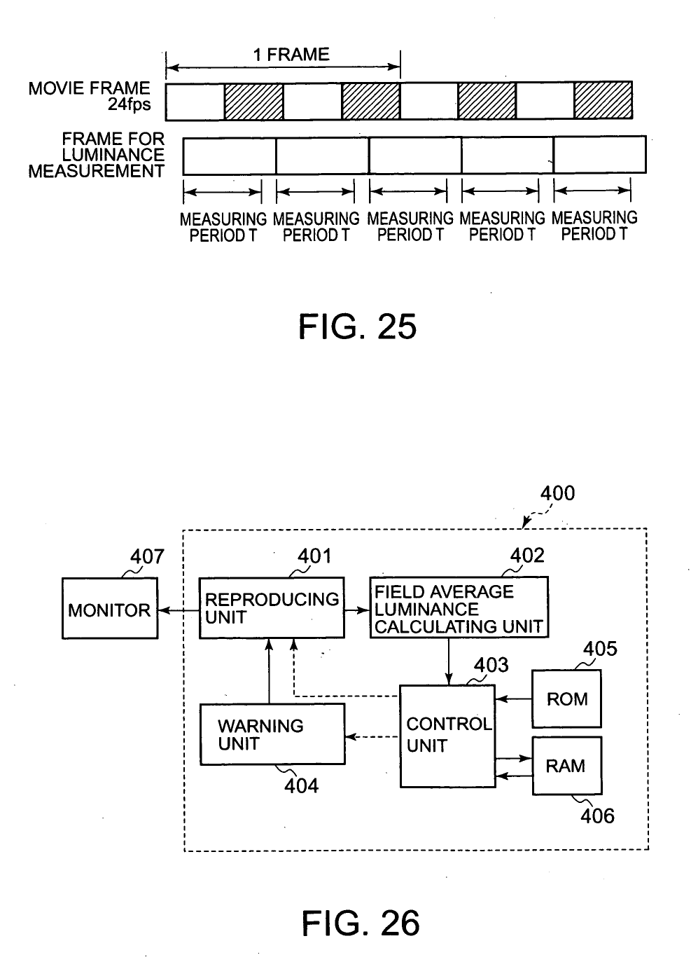

Still, furthermore, although the third embodiment is explained with continuous luminance measurements, the measurements may be performed intermittently, as illustrated in FIG. 25.

The first to third embodiments disclosed above are related to detection and prevention of surreptitious recording of a movie at a theater. Disclosed next is, however, preferred embodiments on interception of reproduction of a movie surreptitiously recorded at a theater, according to the present invention.

### Fourth Embodiment

Disclosed with reference to FIG. 26 is a reproducing apparatus, as a fourth embodiment of the present invention.

A reproducing apparatus 400 shown in FIG. 26 is provided with a reproducing unit 401, a field average luminance calculating unit 402, a control unit 403, a warning unit 404, a ROM 405, and a RAM 406.

The reproducing unit 401 retrieves video signals stored on storage media, such as, a magnetic tape, an HDD, a magnetic disc, a memory, and an optical disc, performs a reproduction procedure with error correction, D/A conversion, etc., and sends the reproduced video signals to an external monitor 407.

The field average luminance calculating unit 402 calculates average luminance per field of the images reproduced at the reproducing unit 401.

The warning unit 404 sends a warning signal to the external monitor 407 via the reproducing unit 401, for displaying a warning message with images, when surreptitious video recording is detected.

The control unit 403 is installed with the detection scheme disclosed in the first embodiment, to determine whether the video signals are reproduced from a surreptitiously recorded movie, according to the average field luminance calculated at the field average luminance calculating unit 402. Nevertheless, the reproducing apparatus 400 may be equipped with a detecting unit (not shown in FIG. 26) installed with the detection scheme disclosed in the first embodiment. In this case, the control unit 403 has the function of the other overall control of reproduction procedures, with no detection function.

The ROM 405 stores the default values disclosed in the first embodiment. The RAM 406 is used as a working area in processing.

The control unit 403 instructs the warning unit 404 to send a warning signal to the reproducing unit 401 when it is determined that the video signals are reproduced from a surreptitiously recorded movie, according to the field average luminance calculated at the field average luminance calculating unit 402. Then, the reproducing unit 401 sends the warning signal to the external monitor 407, together with the video signals, for displaying a warning message with images. Then, the control unit 403 stops reproduction at the reproducing unit 401. A warning message displayed on the external monitor 407 makes a user realize that surreptitious video recording is detected and reproduction is halted.

### Fifth Embodiment

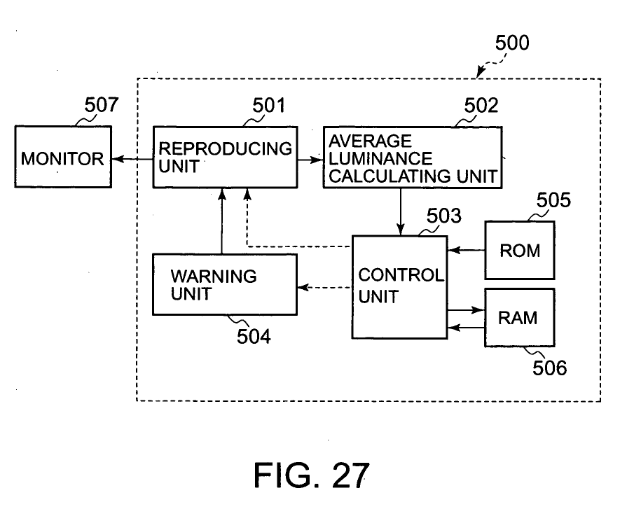

Disclosed with reference to FIG. 27 is a reproducing apparatus, as a fifth embodiment of the present invention.

A reproducing apparatus 500 shown in FIG. 27 is provided with a reproducing unit 501, an average luminance calculating unit 502, a control unit 503, a warning unit 504, a ROM 505, and a RAM 506

The reproducing unit 501 retrieves video signals stored on storage media, such as, a magnetic tape, an HDD, a magnetic disc, a memory, and an optical disc, performs a reproduction procedure with error correction, D/A conversion, etc., and sends the reproduced video signals to an external monitor 507.

The average luminance calculating unit 502 calculates average luminance of the images reproduced at the reproducing unit 501, for each of periods Ts1 and Ts2 for which one field of the images is divided.

The warning unit 504 sends a warning signal to the external monitor 507 via the reproducing unit 501, for displaying a warning message with images, when surreptitious video recording is detected.

The control unit 503 is installed with the detection scheme disclosed in the second embodiment, to determine whether the video signals are reproduced from a surreptitiously recorded movie, according to the average field luminance calculated for the periods Ts1 and Ts2 at the average field luminance calculating unit 502. Nevertheless, the reproducing apparatus 500 may be equipped with a detecting unit (not shown in FIG. 27) installed with the detection scheme disclosed in the first embodiment. In this case, the control unit 503 has the function of the other overall control of reproduction procedures, with no detection function.

The division to periods Ts1 and Ts2 is performed only for luminance measurements, not applied to the video signals to be sent to the external monitor 507, in the fifth embodiment of the reproducing apparatus.

The ROM 505 stores the default values disclosed in the second embodiment. The RAM 506 is used as a working area in processing.

The control unit 503 instructs the warning unit 504 to send a warning signal to the reproducing unit 501 when it is determined that the video signals are reproduced from a surreptitiously recorded movie, according to the field average luminance calculated for the periods Ts1 and TS2 at the average luminance calculating unit 502. Then, the reproducing unit 501 sends the warning signal to the external monitor 507, together with the video signals, for displaying a warning message with images. Then, the control unit 503 stops reproduction at the reproducing unit 501. A warning message displayed on the external monitor 507 makes a user realize that surreptitious video recording is detected and reproduction is halted.

As disclosed above in detail, according to imaging apparatus of the present invention, detection and prevention of surreptitious video recording is achieved with images taken by an imaging apparatus, with no requirement of equipment arrangement or addition at a theater, for example, for wireless, infrared-ray or RF-tag transmission.

According to the present invention, prevention of surreptitious video recording is achieved with no modification or edition to movie films.

Moreover, the reproducing apparatus of the present invention is capable of determining whether reproduced images are those surreptitiously recorded, thus preventing reproduction of the images if determined so.

What is claimed is:

1. An imaging apparatus comprising:
an imaging unit for taking an image and converting the image into a video signal;
a display unit for displaying the image carried the by the video signal;
an average luminance calculating unit for calculating average luminance of the image per first predetermined period;
a detecting unit for calculating a ratio of maximum to minimum average luminance of the average luminance over a second predetermined period that is an integer multiple of the first predetermined period and determining whether the ratio is equal to or higher than a predetermined value, to determine that the image taken by the imaging unit is an image of a movie projected onto a screen when it is determined that the ratio is equal to or higher than the predetermined value; and
a warning unit for sending a warning signal to the display unit when the detecting unit determines that the image taken by the imaging unit is the image of the movie, thus the display unit displays an warning message carried by the warning signal with the image.

2. The imaging apparatus according to claim 1, wherein the average luminance calculating unit calculates the average luminance over the first predetermined period that corresponds to each one field of the video signal, and the detecting unit detects the maximum and the minimum average luminance over the second predetermined period based on the average luminance over each first predetermined period for a plurality fields of the video signal covered by the second predetermined period.

3. The imaging apparatus according to claim 1, wherein the average luminance calculating unit calculates the average luminance over a first period and also over a second period for which the first predetermined period is divided, the first predetermined period corresponding to each one field of the video signal, and the detecting unit detects the maximum and the minimum average luminance over the second predetermined period based on the average luminance over each first period and also over each second period for a plurality fields of the video signal covered by the second predetermined period.

4. The imaging apparatus according to claim 1 further comprising a luminance measuring device for measuring, for each first predetermined period, luminance of light from an object for which the image is being taken by the imaging unit, thereby, the average luminance calculating unit calculating the average luminance of the luminance of the light from the object for which the image is being taken.

5. The imaging apparatus according to claim 1 further comprising a recording unit for recording the image carried by the video signal, wherein the recording unit stops the recording of the image carried by the video signal when the detecting unit determines that the image taken by the imaging unit is the image of the movie.

6. The imaging apparatus according to claim 1 further comprising a recording unit for recording the image carried by the video signal, wherein recording unit records the warning message as superimposed on the image.

7. The imaging apparatus according to claim 1 further comprising a recording unit for recording the image carried by the video signal, wherein the recording unit erases the image thus recorded when the detecting unit determines that the image taken by the imaging unit is the image of the movie.

8. A reproducing apparatus comprising:
a reproducing unit for reproducing an image from a video signal;
an average luminance calculating unit for calculating average luminance of the image reproduced from the video signal per first predetermined period;
a detecting unit for calculating a ratio of maximum to minimum average luminance of the average luminance over a second predetermined period that is an integer multiple of the first predetermined period and determining whether the ratio is equal to or higher than a predetermined value, to determine that the image reproduced from the video signal is an image of a movie projected onto a screen when it is determined that the ratio is equal to or higher than the predetermined value; and
a warning unit for sending a warning signal to the reproducing unit when the detecting unit determines that the image reproduced from the video signal is the image of the movie, thus the reproducing unit sends out an warning message carried by the warning signal with the image for displaying.

9. The reproducing apparatus according to claim 8, wherein the average luminance calculating unit calculates the average luminance over the first predetermined period that corresponds to each one field of the video signal, and the detecting unit detects the maximum and the minimum average luminance over the second predetermined period based on the average luminance over each first predetermined period for a plurality fields of the video signal covered by the second predetermined period.

10. The reproducing apparatus according to claim 8, wherein the average luminance calculating unit calculates the average luminance over a first period and also over a second period for which the first predetermined period is divided, the first predetermined period corresponding to each one field of the video signal, and the detecting unit detects the maximum and the minimum average luminance over the second predetermined period based on the average luminance over each first period and also over each second period for a plurality fields of the video signal covered by the second predetermined period.

11. The reproducing apparatus according to claim 8, wherein the reproducing unit stops the reproduction of the image from the video signal when the detecting unit determines that the image reproduced by the reproducing unit is the image of the movie.

12. The reproducing apparatus according to claim 8, wherein the reproducing unit reproduces the warning message as superimposed on the image.
